(19) United States
(12) Patent Application Publication
(10) Pub. No.: US 2025/0047048 A1
(43) Pub. Date: Feb. 6, 2025

(54) ADJUSTABLE ELECTRICAL CONNECTORS

(71) Applicant: ENPRO, INC., Addison, IL (US)

(72) Inventors: Grant Cook, Wayne, IL (US); Scott Nicholson, South Elgin, IL (US)

(21) Appl. No.: 18/735,976

(22) Filed: Jun. 6, 2024

Related U.S. Application Data
(60) Provisional application No. 63/530,337, filed on Aug. 2, 2023.

(51) Int. Cl. H01R 35/02

(52) U.S. Cl. CPC H01R 35/02

(57) ABSTRACT

An adjustable electrical connector having a first and second sleeve component that are rotatable relative to one another to form either a straight connector or an angled connector. The ends of the sleeve components are angled to allow them to be positioned next to one another and rotate relative to one another. A gasket may be attached to one of the ends to provide a more secure connection. One or more stop members may be utilized to facilitate positioning of the sleeve components relative to one another.

This application claims benefit to U.S. provisional patent application Ser. No. 63/530,337, filed Aug. 2, 2023, the disclosure of which is herein incorporated by reference in its entirety.

### FIELD OF THE INVENTION

This invention relates generally to electrical connectors and, more particularly, to adjustable electrical connectors.

### BACKGROUND OF THE INVENTION

Circular electrical connectors for connecting multiple electronic devices together are well known. Karl Lumberg GmbH & Co. KG introduced the M12 cable connector in 1985 that allowed for quicker, reliable and shielded connections between cables. Among other things, these cables made it quicker and more efficient to install, replace and update cables. Today, such cables are offered under a variety of designations including, but not limited to, M5, M8 and M12 and come in a variety of connector types including, but not limited to screw-type, bayonet style and push-pull locking.

Such connectors were first used for sensors, switches and actuators, but are now used in a number of different industries and for a wide variety of applications including, factory and industrial automation, network and telecommunication, lighting, marine, packaging. The connectors are currently provided in either a straight position or an angled 90-degree position to facilitate directional changing of the cables.

Referring to FIG. 1, two pairs of prior art screw-type electrical cable connectors 10, 110, 12, 112 are shown. The figures show the connectors in both a straight position and an angled position. The male connectors 12,112 include a sleeve 14 that is overmolded over a wire or cord set 16. The end of the sleeve 14 includes an opening 18 to house a plurality of pins or other male members 20. On the exterior of the end of the sleeve are a plurality of threads 22.

The female connectors 10,110 include a sleeve 30 that is overmolded over a wire or cord set 32. The end of the sleeve 30 includes an opening 34 to house a female insert 36 for receiving the male members 20. The female insert includes a plurality of slots 38 corresponding to the plurality of pins 20 on the male connectors 12,112. A coupling nut 40 including a plurality of threads 42 on its interior extends over the outside of the end of the female connectors 10, 110 for selectively engaging the corresponding threads 22 of the male connectors 12,112 to secure the wires 16, 32 together.

Depending on the particular setup of the components to be connected together, either a straight or an angled connector may be better suited for use. However, oftentimes, it is not known until the time of installation what types of connectors will be best suited for the particular arrangement. Accordingly, either an installer needs to carry a large amount of inventory to cover the various types of connector or delays may be encountered during the installation process if the right types of connectors are not readily available.

### BRIEF SUMMARY OF THE INVENTION

The present invention comprises an adjustable cable connector that may be readily converted between a straight connector and an angled connector and vice-versa. The connector includes a pair of sleeve components or members having a substantially circular cross-section that are overmolded or attached to a cord and have angled ends that correspond to one another to allow the second sleeve component to be rotated relative to the first sleeve component between the straight connector and the angled connector. One or more stop members are positioned to limit the rotational movement of the sleeve components (e.g., between 0 and 180 degrees) so that the components may be arranged so that they are aligned substantially in a straight line or 90 degrees between each other. One or more selectively raised surface or other detents may be situated on the end of the sleeve components to retain the components in either the straight or angled positions.

Accordingly, it is an object of the present invention to provide an adjustable cable connector that is economical and easy to install and operate.

It is another object of the present invention to provide an adjustable cable connector that reduces the amount of inventory required for connecting cables.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a front perspective view of a pair of prior art female electrical cable connectors.

FIG. 2 is a front perspective view of a pair of prior art male electrical cable connectors.

FIG. 3 is a front plan view of one embodiment of the adjustable female cable connector of the present invention in the straight position.

FIG. 4 is a front plan view of the adjustable female cable connector of FIG. 3 in the angled position.

FIG. 5A is a front perspective plan view of the adjustable female connector positioned in the angled position.

FIG. 5B is a front perspective view of the adjustable female connector positioned in the straight position.

FIG. 6A is a cross-sectional view of the adjustable female connector of FIG. 5A showing the stop member retaining the connector in the angled position.

FIG. 6B is a cross-sectional view of the adjustable female connector of FIG. 5B showing the stop member retaining the connector in the straight position.

FIGS. 7A to 7D are front perspective views showing an adjustable male connector being rotated between a straight position and an angled position.

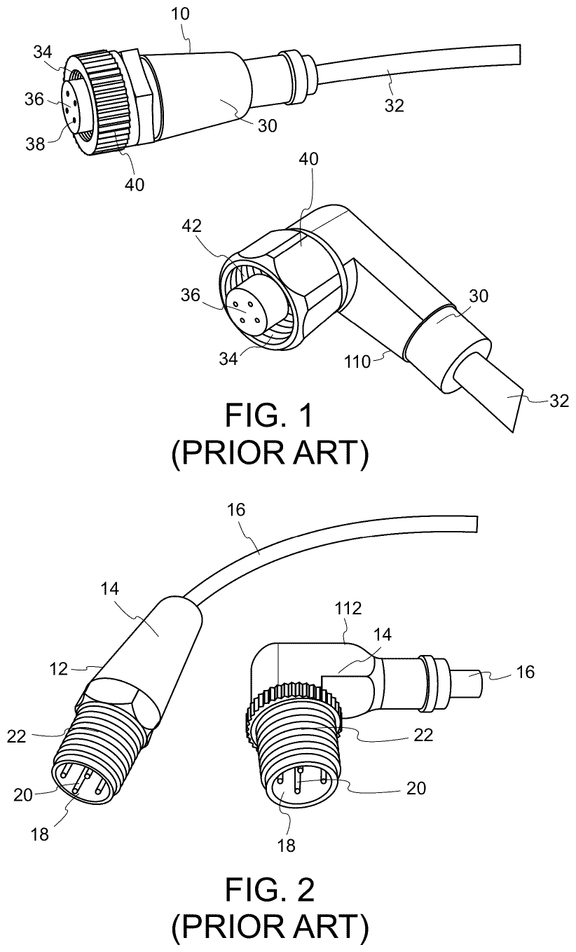

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

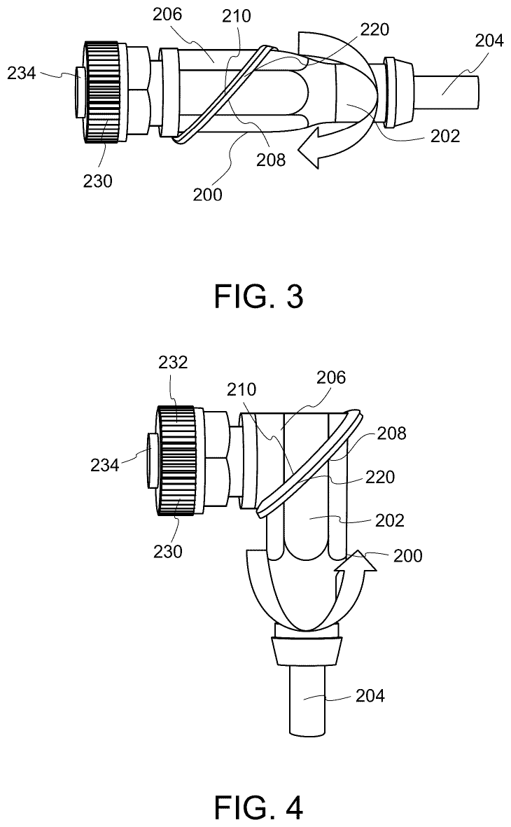

FIGS. 3 and 4 show one embodiment of the adjustable electrical cable connector of the present invention in connection with a female electrical cable screw-type connector. While the drawings show a female electrical cable screw-type connector, it is appreciated that the present invention may be utilized for male connectors and with other types of connectors including, but not limited to push-pull connectors and bayonet style connectors.

Referring again to FIG. 3, the adjustable electrical connector 200 includes a first sleeve component or member 202 overmolded or otherwise connected to a wire, cable or cord 204 and a second sleeve component or member 206 that is separately attached to the cord 204 such that the two sleeve components 202, 206 are positioned adjacent to each other. The sleeve components may be made from an insulated material such as, but not limited to, polyvinyl chloride (PVC) or polyurethane. The sleeve components, or at least the corresponding ends of the sleeve components may have a symmetrical cross-section such as a circle or a square.

The ends 208, 210 of the first and second sleeve components 202, 206 are angled so that they align with one another and, as explained below, may be rotated to create an angled connector. While the embodiment shown in the figures illustrates the ends each extending on a 45 degree angle, it is appreciated that other angles may be utilized and not depart from the scope of the present invention.

The cord 204 may be made from a flexible type of material such as a torsion wire to allow flexibility at the joint when the connector is in the angled position. A gasket 220 or other member may be utilized on the end of the first or second sleeve component 202, 206 to provide a more secure connection between the sleeve components.

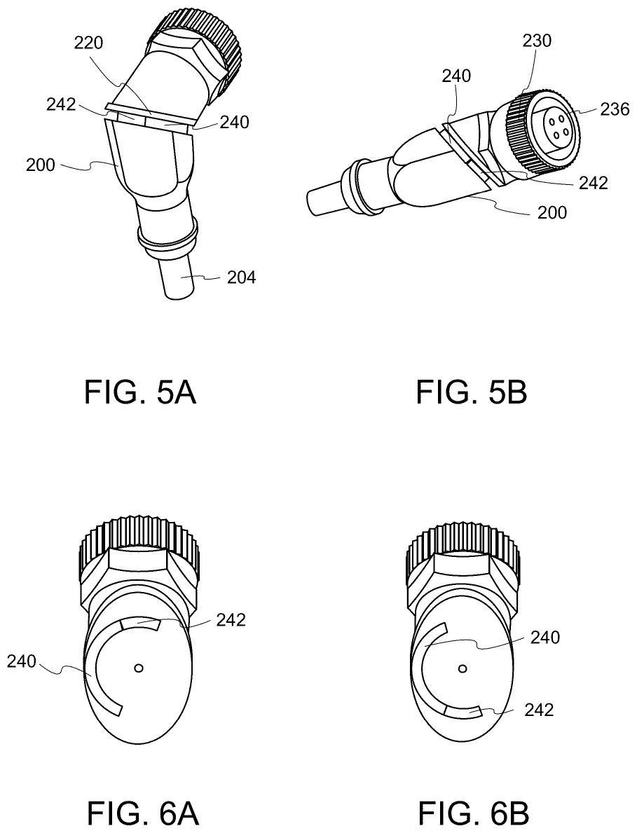

Referring to FIGS. 5 and 6, in lieu of or in addition to the gasket, the end 208 of the first sleeve component 202 may include an arcuate stop member 240 or other known means to limit rotational movement of the second sleeve component 206 relative to the first sleeve component 202. A corresponding arced member 242 may be positioned on the end 210 of the second sleeve component 206 so that rotation of the second sleeve component 206 will rotate the arced member 242 between the angled position (FIG. 6A) and the straight position (FIG. 6B). In one example, the first and second sleeve components 202, 206 may be rotated between 0 and 180 degrees relative to one another. Raised surfaces (not shown) or other detents may be positioned proximate the ends of the stop member 240 for the arced member 242 to pass over and be retained in place to keep the connector 200 in its respective angled or straight position.

While the drawings illustrate the second sleeve component being rotated so that it extends at or substantially at 90 degrees from the first sleeve component, it is appreciated that the connector of the present invention may include additional raised surfaces or detents, or include a smaller or larger stop member to allow the sleeve components to be stopped at a different or a variety of angles from one another to allow flexibility in installation.

Extending from or otherwise attached to the second sleeve component 206 is a coupling nut 230 for connecting the electrical connector 200 to a corresponding male electrical connector such as the one embodied by reference number 12. The coupling nut 230 includes internal threads for engaging corresponding threads 22 on the male electrical connector 12 to connect the two connectors 12, 200 together. The outside of the coupling nut 230 may include grooves or other textured surface 232 to facilitate the grasping and rotation of the coupling nut 230.

A female 234 insert is attached to the end of the cord 204 and extends through the second sleeve component 206 and coupling nut 230. In order to mate with the corresponding male insert or pins 20 of the male electrical connector 12, the female insert 234 may include an equal number of slots for receiving the pins 38.

In operation relative to the embodiment shown and disclosed in FIGS. 3 through 6, in order to convert the connector 200 from a straight connector (as shown in FIG. 3) to an angled connector (as shown in FIG. 4), after grabbing both the first and second sleeve components 202, 206, the second sleeve component 206 is twisted or rotated until it is stopped and secured in position by the stop member 240 and corresponding arc member 242 and raised surfaces. Once in the angled position, it may be attached to a corresponding electrical connector. In order to return the electrical connector 200 to a straight connector, the process is reversed until the second sleeve component 206 is stopped in place by another stop member. While the connector is shown and disclosed as having the sleeve components being angled at or about 90 degrees, it is appreciated that the sleeve components may positionable at other desired angles for particular applications and usages.

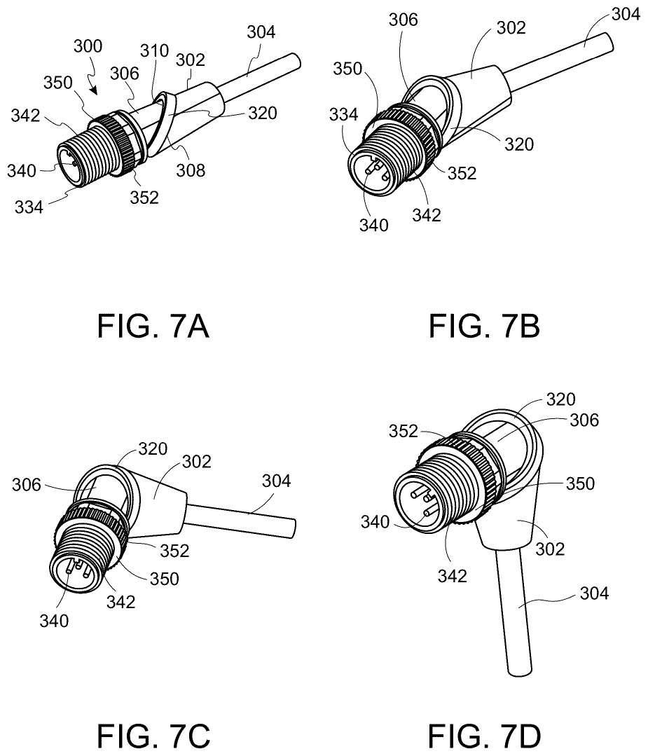

FIGS. 7A through 7D show one embodiment of an adjustable electrical cable connector 300 of the present invention in connection with a male electrical cable screw-type connector. While FIGS. 7A through 7D show a male electrical cable screw-type connector, it is appreciated that the present invention may be utilized for female connectors and with other types of connectors including, but not limited to push-pull connectors and bayonet style connectors.

The adjustable electrical connector 300 includes a first sleeve component 302 overmolded or otherwise connected to a wire, cable or cord 304 and a second sleeve component 306 that is separately attached to the cord 304 such that the two sleeve components 302, 306 are positioned adjacent to each other. The sleeve components may be made from an insulated material such as, but not limited to, polyvinyl chloride (PVC) or polyurethane. The sleeve components 302, 306, or at least the corresponding ends 308, 310 of the sleeve components may have a symmetrical cross-section such as a circle or a square.

The ends 308, 310 of the first and second sleeve components 302, 306 are angled so that they align with one another and, as explained below, may be rotated to create an angled connector. While the embodiment shown in the figures illustrates the ends each extending on a 45 degree angle, it is appreciated that other angles may be utilized and not depart from the scope of the present invention.

The cord 304 may be made from a flexible type of material such as a torsion wire to allow flexibility at the joint when the connector is in the angled position. A gasket 320 or other member may be utilized on the end of the first or second sleeve component 302, 306 to provide a more secure connection between the sleeve components 302, 306.

A male insert 334 is attached to the end the cord 304 or as part of the end of the second sleeve component 306. The male insert 334 is shown including a cylindrical housing that includes a plurality of male inserts of pins 340 that are design to mate with corresponding slots or holes in the female insert 36, 234. The male insert 334 may have a plurality of grooves 342 to mate with corresponding grooves on the coupling nut 40 or female connecting member 12. An annular ring 350 having a plurality of grooves or other textured surfaces 352 is positioned on or about the second sleeve component 306 to facilitate grasping and rotation of the second sleeve component 306 relative to the first sleeve component 302.

In operation relative to the embodiment shown and disclosed in FIGS. 7A to 7D, in order to convert the connector 300 from a straight connector (as shown in FIG. 7A) to an angled connector (as shown in FIG. 7D), after grabbing both the first and second sleeve components 302, 306, the second sleeve component 306 is twisted or rotated until it is stopped and secured in position, by a stop member 240 and corresponding arc member 242 and raised surfaces, or other stopping means. In order to facilitate grasping and rotation of the second sleeve component 306, the grooved or textured ring 350 may be grasped. Once in the angled position, it may be attached to a corresponding electrical connector. While the connector is shown and disclosed as having the sleeve components being angled at or about 90 degrees, it is appreciated that the sleeve components may positionable at other desired angles for particular applications and usages. In order to return the electrical connector 300 to a straight connector, the process is reversed until the second sleeve component 306 is stopped in place by another stop member 240.

It will be understood that modifications and variations may be effected without departing from the spirit and scope of the present invention. It will be appreciated that the present disclosure is intended as an exemplification of the invention and is not intended to limit the invention to the specific embodiment illustrated and described. The disclosure is intended to cover, by the appended claims, all such modifications as fall within the scope of the claims.

1. An adjustable electrical connector comprising:
an electrical conductor;
a first sleeve member operatively connected to the electrical conductor, the first sleeve member having an end having a first angle;
a second sleeve member operatively connected to the electrical conductor, the first sleeve member having an end having a second angle, the end of the first sleeve member and the end of the second sleeve member are positioned proximate to one another, wherein the at least one of the first and second sleeve members is rotatable relative to the other sleeve member to form a straight connector or an angled connector; and
at least one stop member to limit the rotational movement of the first sleeve member relative to the second sleeve member.

2. The adjustable electrical connector of claim 1 wherein the electrical conductor is a wire.

3. The adjustable electrical connector of claim 1 wherein the electrical conductor is torsion wire.

4. The adjustable electrical connector of claim 1 wherein the electrical conductor is a cord.

5. The adjustable electrical connector of claim 1 wherein the first angle and the second angle are 45 degrees.

6. The adjustable electrical connector of claim 1 which further comprises a gasket attached to the end of one of the first sleeve member and the second sleeve member.

7. The adjustable electrical connector of claim 1 wherein the stop member is positioned on the end of the second sleeve member.

8. The adjustable electrical connector of claim 7 wherein the stop member is arced and has a first end and a second end.

9. The adjustable electrical connector of claim 8 which further includes a raised member on the end of the first electrical connector that is positioned to move between the first end and the second end of the stop member.

10. The adjustable electrical connector of claim 9 which further includes raised surfaces on the end of the first connector member proximate the first and second ends of the stop member, wherein the raised member may pass one of the raised surfaces to be retain the connector in either a straight or an angled position.

11. The adjustable electrical connector of claim 1 wherein the angled connector is a right-angled connector.

12. An adjustable electrical connector comprising:
an electrical conductor;
a first sleeve member operatively connected to the electrical conductor, the first sleeve member having an end having a first angle;
a second sleeve member operatively connected to the electrical conductor, the first sleeve member having an end having a second angle, the end of the first sleeve member and the end of the second sleeve member are positioned proximate to one another, wherein the at least one of the first and second sleeve members is rotatable relative to the other sleeve member to form a straight connector or a right-angled connector;
a gasket attached to the end of one of the first sleeve member and the second sleeve member and
at least one stop member to limit the rotational movement of the first sleeve member relative to the second sleeve member.

13. The adjustable electrical connector of claim 12 wherein the stop member is positioned on the end of the second sleeve member.

14. The adjustable electrical connector of claim 13 wherein the stop member is arced and has a first end and a second end.

15. The adjustable electrical connector of claim 14 which further includes a raised member on the end of the first electrical connector that is positioned to move between the first end and the second end of the stop member.

16. The adjustable electrical connector of claim 15 which further includes raised surfaces on the end of the first connector member proximate the first and second ends of the stop member, wherein the raised member may pass one of the raised surfaces to be retain the connector in either a straight or an angled position.
